(19) United States
(12) Patent Application Publication
(10) Pub. No.: US 2011/0314827 A1
(43) Pub. Date: Dec. 29, 2011

(54) FUEL NOZZLE ASSEMBLY

(75) Inventors: Sachin Khosla, Greenville, SC (US); Timothy Andrew Healy, Simpsonville, SC (US); Daniel Scott Zehentbauer, Marysville, OH (US)

(73) Assignee: GENERAL ELECTRIC COMPANY, Schenectady, NY (US)

(21) Appl. No.: 12/822,582

(22) Filed: Jun. 24, 2010

(51) Int. Cl. F02C 7/22

(52) U.S. Cl. 60/742

(57) ABSTRACT

An insert for pre-mixing a secondary fuel in a pre-mixing annulus of a fuel nozzle assembly is disclosed. The insert includes a cartridge extending through at least a portion of the fuel nozzle assembly and configured to flow the secondary fuel therethrough. The insert further includes an adapter coupled to the cartridge, the adapter defining a fuel plenum and at least one radially extending injection bore. The at least one injection bore is configured to accept at least a portion of the secondary fuel from the cartridge and inject the secondary fuel into the pre-mixing annulus.

### FIELD OF THE INVENTION

The present disclosure relates generally to gas turbine systems, and more particularly to fuel nozzle assemblies in gas turbine systems.

### BACKGROUND OF THE INVENTION

Gas turbine systems are widely utilized in fields such as power generation. A conventional gas turbine system includes a compressor, a combustor, and a turbine. In a typical gas turbine system, compressed air is provided from the compressor to the combustor. The air entering the combustor is mixed with fuel and combusted, Hot gases of combustion flow from the combustor to the turbine to drive the gas turbine system and generate power.

Natural gas is typically utilized as a primary fuel for a gas turbine system. The natural gas is mixed with air in a fuel nozzle assembly in or adjacent to the combustor to provide a lean, pre-mixed air/fuel mixture for combustion. Gas turbine systems typically also require a secondary fuel that allows the system to continue to run when the primary fuel is not available. The secondary fuel is typically a liquid fuel, such as oil.

Typical prior art solutions for providing secondary fuel in a fuel nozzle assembly supply the secondary fuel as a fuel stream sprayed directly into or adjacent to an ignition source. This fuel stream is a relatively rich fuel mixture, as opposed to the relatively lean pre-mixed air/ fuel mixture obtained when using the primary fuel. Consequently, the temperature of the combusted secondary fuel mixture and the resulting rate of NOₓ formation are typically undesirably high. To lower the temperature and NOₓ level, water and compressed atomizing air are typically supplied and mixed with the secondary fuel as the fuel is sprayed into the ignition source. However, this system is relatively inefficient, wasteful, and expensive. For example, independent systems must be utilized to supply the water and to supply and compress the atomizing air.

Further, as the secondary fuel is supplied and flowed through the fuel nozzle assembly, it may cause coking. Coking is the oxidative pyrolysis or destructive distillation of fuel molecules into smaller organic compounds, and further into solid carbon particles, at high temperatures. Coking thus causes the deposition of solid carbon particles onto various surfaces of the fuel nozzle assembly, leading to the disruption of flow in the fuel nozzle assembly.

Thus, an apparatus for pre-mixing a secondary fuel in a fuel nozzle assembly would be desired in the art. Additionally, an apparatus for supplying a secondary fuel in a fuel nozzle assembly that reduces the associated expenses and increases the associated efficiency would be advantageous. Further, an apparatus for supplying a secondary fuel in a fuel nozzle assembly that prevents or reduces coking in the fuel nozzle assembly would be desired.

### BRIEF DESCRIPTION OF THE INVENTION

Aspects and advantages of the invention will be set forth in part in the following description, or may be obvious from the description, or may be learned through practice of the invention.

In one embodiment, an insert for pre-mixing a secondary fuel in a pre-mixing annulus of a fuel nozzle assembly is disclosed. The insert includes a cartridge extending through at least a portion of the fuel nozzle assembly and configured to flow the secondary fuel therethrough. The insert further includes an adapter coupled to the cartridge, the adapter defining a fuel plenum and at least one radially extending injection bore. The at least one injection bore is configured to accept at least a portion of the secondary fuel from the cartridge and inject the secondary fuel into the pre-mixing annulus.

In another embodiment, a fuel nozzle assembly for pre-mixing a secondary fuel is disclosed. The fuel nozzle assembly includes an outer burner tube and an inner burner tube defining a pre-mixing annulus therebetween, the inner burner tube further defining an inner annulus. The fuel nozzle assembly further includes an insert, the insert including a cartridge extending through at least a portion of the fuel nozzle assembly and configured to flow the secondary fuel therethrough, and an adapter coupled to the cartridge and the inner burner tube, the adapter defining a fuel plenum and at least one radially extending injection bore. The injection bore is configured to accept at least a portion of the secondary fuel from the cartridge and inject the secondary fuel into the pre-mixing annulus.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional view of several portions of a gas turbine system of the present disclosure;

FIG. 2 is a cross-sectional view of one embodiment of an insert in a fuel nozzle assembly of the present disclosure;

FIG. 3 is a perspective view of one embodiment of the adapter of the present disclosure as shown in FIG. 2;

FIG. 4 is a cross-sectional view of another embodiment of an insert of the present disclosure;

FIG. 5 is a cross-sectional view of another embodiment of an insert of the present disclosure; and

FIG. 6 is a cross-sectional view of another embodiment of an insert of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

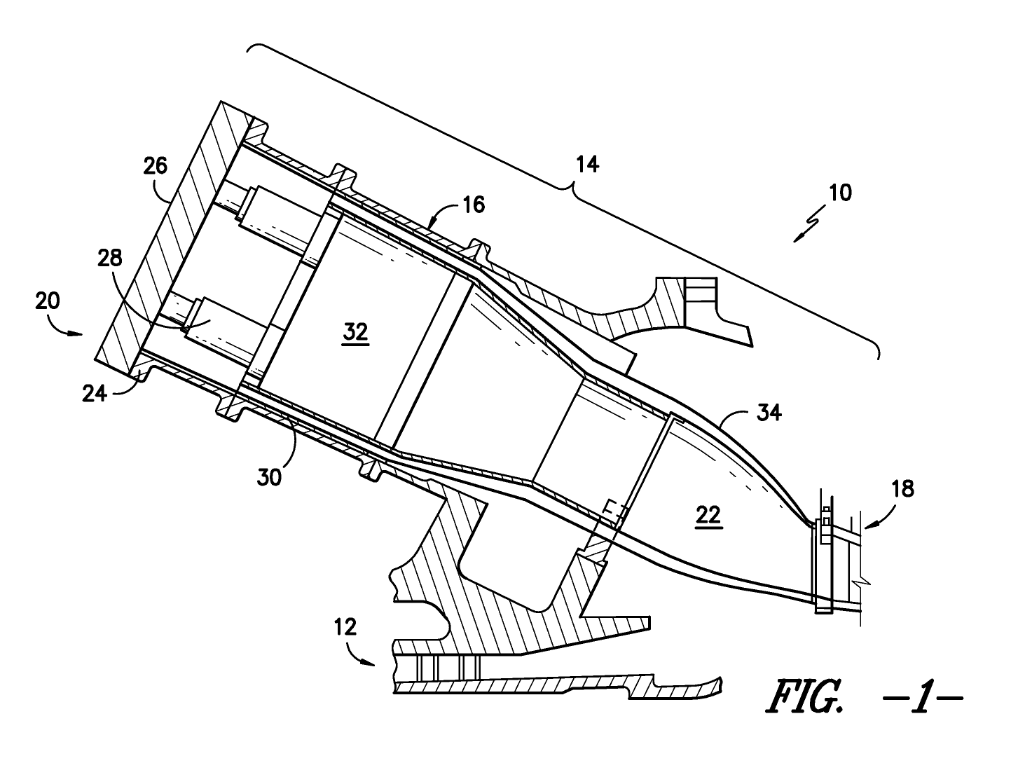

Referring to FIG. 1, a simplified drawing of several portions of a gas turbine system 10 is illustrated. The system 10 comprises a compressor section 12 for pressurizing a gas, such as air, flowing into the system 10. It should be understood that while the gas may be referred to herein as air, the gas may be any gas suitable for use in a gas turbine system 10. Pressurized air discharged from the compressor section 12 flows into a combustor section 14, which is generally characterized by a plurality of combustors 16 (only one of which is illustrated in FIG. 1) disposed in an annular array about an axis of the system 10. The air entering the combustor section 14 is mixed with fuel and combusted. Hot gases of combustion flow from each combustor 16 to a turbine section 18 to drive the system 10 and generate power.

Still referring to FIG. 1, each combustor 16 in the gas turbine 10 may include a combustion system 20 for mixing and combusting an air/fuel mixture, and a transition piece 22 for flowing hot gases of combustion to the turbine section 18. The combustion system 20 of each combustor 16 may include a combustion casing 24, an end cover 26, and a plurality of fuel nozzle assemblies 28. It should also be appreciated that each combustor 16 and combustion system 20 may include any number of fuel nozzle assemblies 28. Fuel may be supplied to each fuel nozzle assembly 28 by one or more manifolds (not shown).

During operation, pressurized air exiting the compressor section 12 flows into each combustor 16 through a flow sleeve 30 of a combustion chamber 32 and an impingent sleeve 34 of the transition piece 22, where it is swirled and mixed with fuel injected into each fuel nozzle assembly 28. The air/fuel mixture exiting each fuel nozzle assembly 28 flows into the combustion chamber 32, where it is combusted. The hot gases of combustion then flow through a transition piece 22 to the turbine section 18 in order to drive the system 10 and generate power. It should be readily appreciated, however, that a combustor 16 need not be configured as described above and illustrated herein and may generally have any configuration that permits pressurized air to be mixed with fuel, combusted and transferred to a turbine section 18 of the system 10.

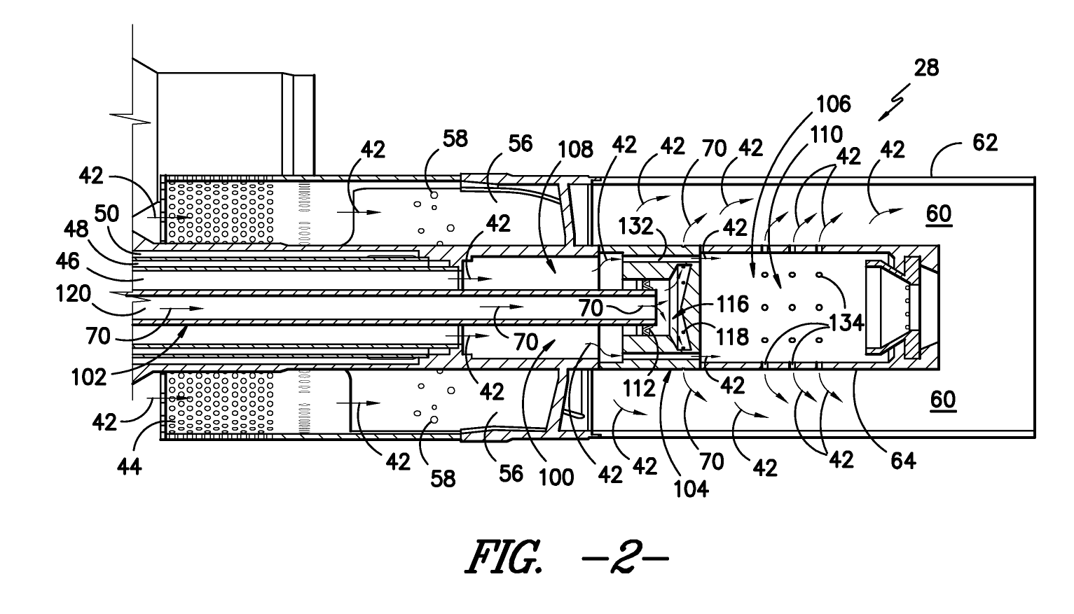

Referring to FIG. 2, a fuel nozzle assembly 28 is illustrated. Air 42 to be combusted may flow through an outer annulus of the fuel nozzle assembly 28, as discussed herein. As shown, the fuel nozzle assembly 28 may include an inlet flow conditioner 44 to improve the air flow velocity distribution of the air 42. The fuel nozzle assembly 28 may also include plurality of concentric tubes defining discrete annular passages 46, 48, and 50. Passage 46 may supply a flow of air, while passages 48 and 50 may supply a primary fuel (not shown), such as natural gas, through the fuel nozzle assembly 28. The primary fuel may further be supplied to the combustion chamber 36 of the combustor 16 (FIG. 1) through a plurality of air swirler vanes 56. Air 42 flowing from the inlet flow conditioner 44 may be directed through the air swirler vanes 56 to impart a swirling pattern to the air 42 and to facilitate the mixing of the air 42 with the primary fuel. The air swirler vanes 56 may include fuel injection ports or holes 58 that inject primary fuel flowing from the passages 48 and 50 into the air 42. The air 42 and primary fuel may then flow into a pre-mixing annulus 60, defined by an outer burner tube 62 and an inner burner tube 64, wherein the air 42 and primary fuel are mixed prior to entering the combustion chamber 36. However, it should be readily appreciated that the fuel nozzle assembly 28 as described above may be configured or arranged in any manner generally known to those of ordinary skill and need not be configured as described.

In exemplary embodiments, when the primary fuel is not available for use with the system 10 and fuel nozzle assemblies 28 of the present disclosure or when otherwise desired, a secondary fuel 70 may be flowed through the fuel nozzle assemblies 28, mixed with air 42, and combusted. The secondary fuel 70 may, in exemplary embodiments, be a liquid fuel, such as oil or an oil mixture. However, it should be understood that the secondary fuel of the present disclosure may be any suitable fuel for use in a fuel nozzle assembly 28.

An insert 100 may thus be provided in the fuel nozzle assembly 28 for flowing the secondary fuel 70 therethrough. The insert 100 of the present disclosure may advantageously allow pre-mixing of the secondary fuel 70 with air 42 in the pre-mixing annulus 60 of the fuel nozzle assembly 28, such that the air/fuel mixture provided to and combusted in the combustion chamber 36 is a relatively lean mixture. Additionally, the air/fuel mixture may beneficially be atomized in the pre-mixing annulus 60. Further, the insert 100 of the present disclosure may prevent or reduce coking in the fuel nozzle assembly 28, as discussed below.

As shown in FIGS. 2 through 6, the insert 100 may include a cartridge 102 and an adapter 104. The cartridge 102 may extend through at least a portion of the fuel nozzle assembly 28, and may be configured to flow the secondary fuel 70 therethrough. For example, the cartridge 102 may be a tube, pipe, conduit, or other suitable apparatus. The cartridge 102 may accept secondary fuel 70 from one or more secondary fuel manifolds (not shown), and the secondary fuel 70 may flow through the cartridge 102, as discussed herein. The cartridge 102 may generally be disposed within the inner burner tube 64. For example, the cartridge 102 may extend through the passage 46. Further, the inner burner tube 64 may define an inner annulus 106. The inner annulus 106 may be in fluid communication with the passage 46. The cartridge 102 may extend through the inner annulus 106. The cartridge 102 may have any suitable cross-sectional shape or size. For example, in some embodiments, the cartridge 102 may have a generally circular or oval cross-section. Further, the cartridge 102 need not be linear or of uniform cross-section along its length; for example, the cartridge 102 could curve and/or taper.

The adapter 104 may be coupled to the cartridge 102 and disposed in the fuel nozzle assembly 28. Further, the adapter 104 may be coupled to the inner burner tube 64. For example, the adapter 104 in certain embodiments may be joined, such as through welding, or may be fastened, such as through a suitable mechanical fastening device or sealing device, to the inner burner tube 64, and may be retrofitted to existing inner burner tubes 64 if desired. Alternatively, the adapter 104 may be an integral component of the inner burner tube 64. Further, the adapter 104 may be positioned in the fuel nozzle 28 such that the inner annulus 106 is divided into an upstream inner annulus 108 and a downstream inner annulus 110.

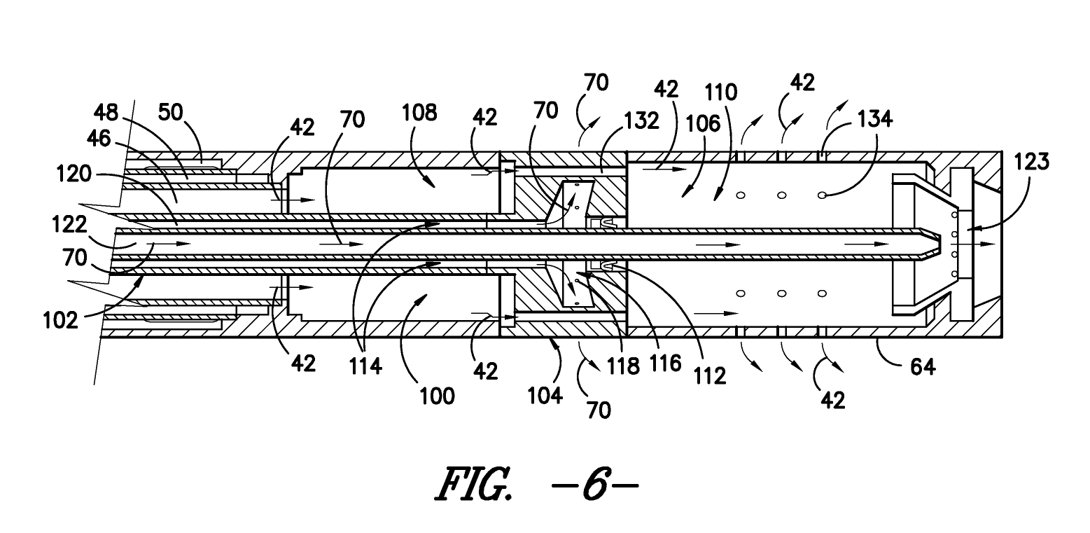

The cartridge 102 may, as shown in FIGS. 2 and 4 through 5, be fastened to the adapter 104. For example, the cartridge 102 may fastened to the adapter through the use of a seal component or components 112. The seal component 112 may be, for example, an annular lip seal ring or other suitable sealing device. It should be understood that portions of the cartridge 102, such as inner passages as discussed below, may extend through or past the seal component 112. Alternatively or additionally, the cartridge 102 may, as shown in FIG. 6, be joined to the adapter 104. For example, the cartridge 102 may be joined, such as through welding, to the adapter 104 at junction 114 or at any other suitable junction. It should be understood that portions of the cartridge 102, such as inner passages as discussed below, may extend through or past the junction 114.

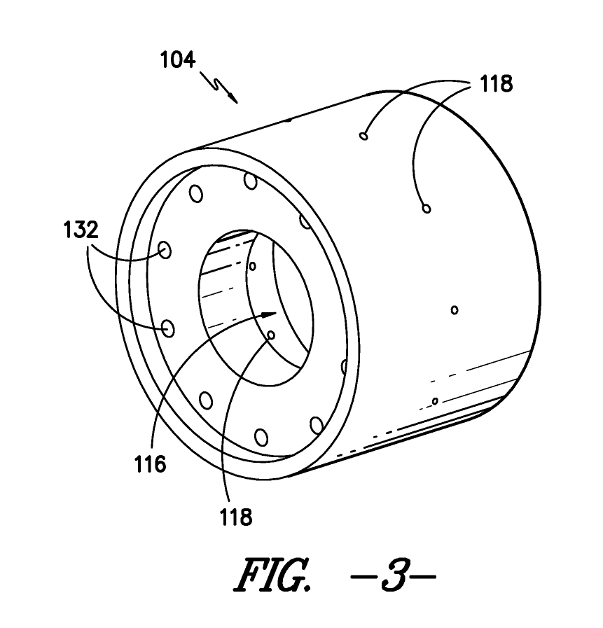

The adapter 104, one embodiment of which is shown in FIG. 3, may define a fuel plenum 116 and at least one radially extending injection bore 118, or a plurality of radially extending injection bores 118. The injection bores 118 may be configured to accept at least a portion of the secondary fuel 70 from the cartridge 102, and may inject the secondary fuel 70 into the pre-mixing annulus 60. For example, the secondary fuel 70 may flow through the cartridge 102. At least a portion of the secondary fuel 70 may exit the cartridge 102 into the fuel plenum 116. The secondary fuel 70 in the fuel plenum 116 may then be communicated through the injection bores 118. The injection bores 118 may extend radially outward through the adapter 104 to the outer surface of the adapter 104, which may be exposed in the pre-mixing annulus 60. Thus, the secondary fuel 70 may flow from the fuel plenum 116 through the injection bores 118 into the pre-mixing annulus 60. The secondary fuel 70, once injected from the injection bores 118 into the pre-mixing annulus 60, may mix with air 42 downstream of the air swirler vane 56, thus allowing pre-mixing of the secondary fuel 70.

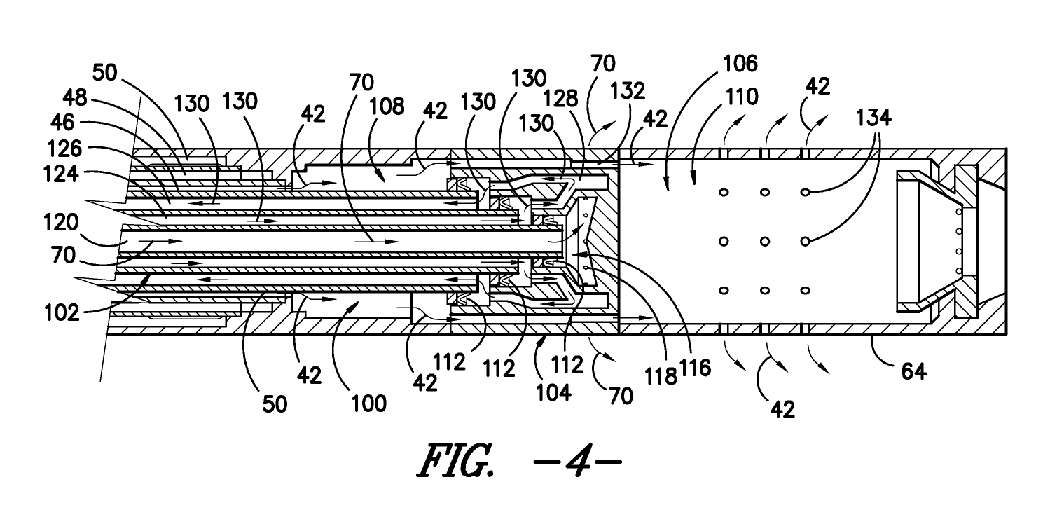

The cartridge 102 of the present disclosure may define a passage or a plurality of passages. The passages may be configured to flow the secondary fuel 70 or another fluid therethrough. In exemplary embodiments, as shown in FIGS. 4 through 6, the plurality of passages may be concentrically aligned passages. It should be understood that the passages may be aligned as shown in FIGS. 4 through 6, or may be aligned in any other suitable arrangement.

As shown in FIGS. 2 and 4 through 6, the cartridge 102 may define a pre-mix passage 120. The pre-mix passage 120 may be in fluid communication with the adapter 104. At least a portion of the secondary fuel 70 flowing through the cartridge 102 may flow through the pre-mix passage 120 into the fuel plenum 116, for injection into the pre-mixing annulus 60.

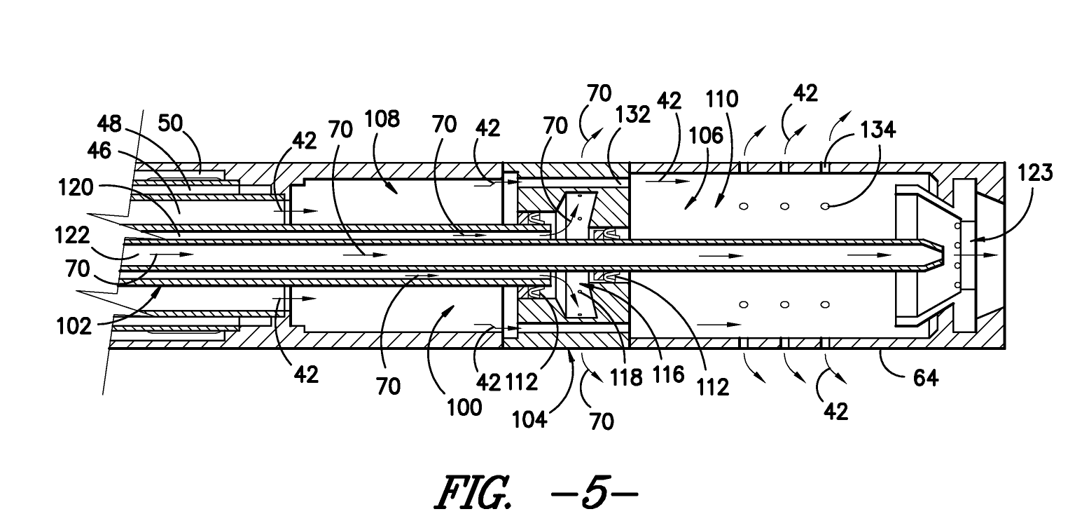

The cartridge 102 may further define a diffusion passage 122, as shown in FIGS. 5 and 6. The diffusion passage 122 may be configured to bypass the adapter 104. For example, a portion of the secondary fuel 70 flowing through the cartridge 102 may flow through the diffusion passage 122. This portion of the secondary fuel 70 may be flowed through the diffusion passage 122 and supplied to a tip 123 of the fuel nozzle assembly 28. A pilot flame (not shown) disposed adjacent the tip 123 may ignite the secondary fuel 70 exiting the diffusion passage 122 and the tip 123. Secondary fuel 70 supplied through the diffusion passage 122 may be utilized as a backup system to the secondary fuel 70 supplied through pre-mix passage 120 for pre-mixing, or may be utilized in conjunction with the pre-mix passage 120 or otherwise as desired.

The cartridge 102 may further define a coolant inlet passage 124 and a coolant outlet passage 126, as shown in FIG. 4. In exemplary embodiments, the adapter may define at least one coolant manifold 128, or a plurality of coolant manifolds 128. The coolant manifolds 128 may be in fluid communication with the coolant inlet passage 124, and may further be in fluid communication with the coolant outlet passages 126. The coolant inlet passage 124 may be configured to provide a coolant 130, such as air 42 or any other suitable coolant, to the adapter 104. For example, the coolant 130 may be supplied from a coolant supply manifold (not shown) to the cartridge 102. The coolant 130 may flow through the coolant inlet passage 124, and may be supplied to the adapter 104. In exemplary embodiments, the coolant 130 may be supplied to the adapter 104 through the coolant manifolds 128 defined in the adapter. The coolant manifolds 128 may flow the coolant 130 therethrough, cooling the adapter 104, and also preventing or reducing coking by providing a flow to loosen and remove existing coking and prevent the deposition of coking. The coolant manifolds 128 may then supply the coolant 130 to the coolant outlet passage 126. The coolant outlet passage 126 may flow the coolant 130 therethrough, exhausting the coolant 130. The coolant 130 may be exhausted exterior to the fuel nozzle assembly 28, or may be exhausted into passage 46 for recirculation through the fuel nozzle assembly 28, or may be otherwise exhausted in any other suitable form.

It should be understood that the flow of secondary fuel 70, coolant 130 or any other fluid through the various passages of the cartridge 102 may be controlled and regulated manually or by utilizing a suitable control system.

In exemplary embodiments, the adapter 104 of the present disclosure may define at least one longitudinally extending bypass passage 132, or a plurality of longitudinally extending bypass passages 132. The bypass passages 132 may be configured to flow air 42 or coolant 130 through the adapter 104. For example, as discussed above, the adapter 104 may be coupled to the inner burner tube 64, and may divide the inner annulus 106 into an upstream inner annulus 108 and a downstream inner annulus 110. The bypass passages 132 may be in fluid communication with the inner annulus 106. For example, the bypass passages 132 may be in fluid communication with both the upstream inner annulus 108 and the downstream inner annulus 110. Thus, air 42 or coolant 130 flowing through the passage 46 into the annulus 106, such as into the upstream inner annulus 108, may flow through the bypass passages 132 and into the downstream inner annulus 110. The air 42 or coolant 130 flowing through the bypass passages 132 may cool the adapter 104, and may further prevent or reduce coking by providing a flow to loosen and remove existing coking and prevent the deposition of coking.

In exemplary embodiments, the inner burner tube 64 may define at least one radially extending coolant bore 134, or a plurality of radially extending coolant bores 134. The coolant bores 134 may be provided in the inner burner tube 64 adjacent the downstream inner annulus 110, At least a portion of the air 42 or coolant 130 provided to the downstream inner annulus 110 may thus be flowed through coolant bores 134 and into the pre-mixing annulus 60. The coolant bores 134 may be sized, shaped, and arranged such that the air 42 or coolant 130 flowing through the coolant bores 134 provides film cooling to the inner burner tube 64, cooling the inner burner tube 64, and further preventing or reducing coking on the outer surface of the burner tube 64 by providing a film to loosen and remove existing coking and prevent the deposition of coking.

The insert 100 of the present disclosure advantageously provides pre-mixing of secondary fuel 70 in fuel nozzle assemblies 28 of gas turbines 10. Further, the insert 100 reduces the expenses and increases the efficiency associated with providing the secondary fuel. For example, the insert 100 does not require the use of water to cool the combusted secondary fuel 70, and further does not require an independent compressed atomizing air source. Additionally, the insert 100 provides various air and coolant flows throughout the fuel nozzle assembly 28 to prevent or reduce coking in the fuel nozzle assembly 28 due to the use of the secondary fuel 70.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An insert for pre-mixing a secondary fuel in a pre-mixing annulus of a fuel nozzle assembly, the insert comprising:
a cartridge extending through at least a portion of the fuel nozzle assembly and configured to flow the secondary fuel therethrough; and
an adapter coupled to the cartridge, the adapter defining a fuel plenum and at least one radially extending injection bore,
wherein the at least one injection bore is configured to accept at least a portion of the secondary fuel from the cartridge and inject the secondary fuel into the pre-mixing annulus.

2. The insert of claim 1, the cartridge defining a pre-mix passage, the pre-mix passage in fluid communication with the adapter.

3. The insert of claim 1, the cartridge defining a diffusion passage configured to bypass the adapter.

4. The insert of claim 3, wherein a portion of the secondary fuel is flowed through the diffusion passage and supplied to a tip of the fuel nozzle assembly.

5. The insert of claim 1, the cartridge defining a coolant inlet passage configured to provide a coolant to the adapter.

6. The insert of claim 5, the cartridge defining a coolant outlet passage configured to accept the coolant from the adapter.

7. The insert of claim 5, the adapter defining at least one coolant manifold, the at least one coolant manifold in fluid communication with the coolant inlet passage.

8. The insert of claim 1, the adapter defining at least one longitudinally extending bypass passage.

9. The insert of claim 1, wherein the cartridge is joined to the adapter.

10. The insert of claim 1, further comprising at least one seal component, the at least one seal component configured to fasten the cartridge and the adapter together.

11. A fuel nozzle assembly for pre-mixing a secondary fuel, the fuel nozzle assembly comprising:
an outer burner tube and an inner burner tube defining a pre-mixing annulus therebetween, the inner burner tube further defining an inner annulus; and
an insert, the insert including a cartridge extending through at least a portion of the fuel nozzle assembly and configured to flow the secondary fuel therethrough, and an adapter coupled to the cartridge and the inner burner tube, the adapter defining a fuel plenum and at least one radially extending injection bore,
wherein the at least one injection bore is configured to accept at least a portion of the secondary fuel from the cartridge and inject the secondary fuel into the pre-mixing annulus.

12. The fuel nozzle assembly of claim 11, the inner burner tube defining at least one radially extending coolant bore.

13. The fuel nozzle assembly of claim 11, the cartridge defining a pre-mix passage, the pre-mix passage in fluid communication with the adapter.

14. The fuel nozzle assembly of claim 11, the cartridge defining a diffusion passage configured to bypass the adapter.

15. The fuel nozzle assembly of claim 14, further comprising a tip, and wherein a portion of the secondary fuel is flowed through the diffusion passage and supplied to the tip.

16. The fuel nozzle assembly of claim 11, the cartridge defining a coolant inlet passage configured to provide a coolant to the adapter.

17. The fuel nozzle assembly of claim 16, the cartridge defining a coolant outlet passage configured to accept the coolant from the adapter.

18. The fuel nozzle assembly of claim 16, the adapter defining at least one coolant manifold, the at least one coolant manifold in fluid communication with the coolant inlet passage.

19. The fuel nozzle assembly of claim 11, the adapter defining at least one longitudinally extending bypass passage.

20. The fuel nozzle assembly of claim 19, wherein the at least one bypass passage is in fluid communication with the inner annulus.
